(19) United States
(12) Patent Application Publication
(10) Pub. No.: US 2025/0372277 A1
(43) Pub. Date: Dec. 4, 2025

(54) USE OF GRAPHENE-REINFORCED ULTRA-CONDUCTIVE COPPER IN FIELD OF HIGH-CURRENT DEVICES

(71) Applicant: AMAZING COOL TECHNOLOGY CORPORATION, New Taipei (CN)

(72) Inventors: YANG-MING SHIH, New Taipei (CN); HUNG-YUN HSU, New Taipei (CN); CHING-LIN YANG, New Taipei (CN); YING-LU CHEN, New Taipei (CN); RUEI-BIN PAN, New Taipei (CN)

(73) Assignee: AMAZING COOL TECHNOLOGY CORPORATION, New Taipei (CN)

(21) Appl. No.: 19/299,380

(22) Filed: Aug. 14, 2025

Related U.S. Application Data
(63) Continuation-in-part of application No. PCT/CN2024/094184, filed on May 20, 2024.

(30) Foreign Application Priority Data
Feb. 20, 2024 (CN) 202410187513.1

(51) Int. Cl. H01B 1/02

(52) U.S. Cl. CPC H01B 1/026

(57) ABSTRACT

A use of graphene-reinforced ultra-conductive copper in a field of high-current devices is provided. In the graphene-reinforced ultra-conductive copper, carbon atoms of graphene are distributed in gaps among copper atoms. This structure can lead to an exceptionally robust internal structure for the copper material, and thus makes the copper material have properties such as low temperature coefficient of resistance (TCR), small coefficient of thermal expansion (CTE), and high current density. Therefore, the graphene-reinforced ultra-conductive copper is suitable for devices requiring a high current and a low temperature, including electric vehicles (charging/motors/signals), drones, semiconductor electronics, and defense/military-grade wires. The graphene-reinforced ultra-conductive copper is a novel conductor material that integrates energy conservation, heat reduction, pressure resistance, and cost effectiveness.

### CROSS REFERENCE TO THE RELATED APPLICATIONS

This application is a continuation-in-part application of International Application No. PCT/CN2024/094184, filed on May 20, 2024, which is based upon and claims priority to Chinese Patent Application No. 202410187513.1, filed on Feb. 20, 2024, the entire contents of which are incorporated herein by reference.

### TECHNICAL FIELD

The present disclosure relates to the technical field of conductor materials, and in particular relates to a use of graphene-reinforced ultra-conductive copper in a field of high-current devices.

### BACKGROUND

Since the discovery of electricity by humans, countless scientists have investigated and developed a theory and application of electricity. After centuries of effort, electricity has become an indispensable part of people's lives. In recent years, electric vehicles and 5G communication have emerged as highly significant industry trends. The efficiencies of high-frequency electric signal transmission, electric power transmission, electromagnetic conversion, etc. are critically important. Conductor materials for transmitting electric energy and signals are the most pivotal materials.

To determine whether a material is a prominent conductor, the corresponding measurement criteria have been established in the International Annealed Copper Standard (IACS). The electrical conductivity of annealed pure copper with resistivity of 1.724×10⁻⁸ (Ω·m) at 20° C. is set at 100% IACS. Compared with pure copper, the pure silver with resistivity of 1.626×10⁻⁸ (Ω·m) has electrical conductivity calculated to be 106% IACS. Pure silver demonstrates the highest electrical conductivity among natural materials.

Although pure copper has electrical conductivity of 100% and resistivity of 1.724×10⁻⁸ (Ω·m), the resistivity of a round wire conductor that is made of pure copper and has a length of 1 m and a diameter of 2 mm is calculated to be 5.48 mΩ. When a current flows through this round wire conductor, the power dissipation occurs as follows: P=I²R. If a current of 100 A flows through the copper conductor, the electric energy of 10,000×0.00548=54.8 (W) will be consumed. The electric energy consumed will be converted into thermal energy, which causes a temperature of the copper conductor to arise. The temperature rise of the copper conductor will increase the impedance of the copper conductor, making the power consumption and temperature increase. This vicious circle ultimately results in the breakdown of a system, which is known as thermal breakdown.

Therefore, reducing the thermal breakdown of copper conductors and the consumption of copper materials is an urgent problem to be solved in the art.

### SUMMARY

An objective of the present disclosure is to provide a use of graphene-reinforced ultra-conductive copper in a field of high-current devices. The graphene-reinforced ultra-conductive copper has characteristics such as low temperature coefficient of resistance (TCR), small coefficient of thermal expansion (CTE), and high current density, and can be used for high-current devices. The graphene-reinforced ultra-conductive copper can reduce the thermal breakdown of copper conductors and the consumption of copper materials.

To achieve the above objective of the present disclosure, the present disclosure provides the following technical solutions:

The present disclosure provides a use of graphene-reinforced ultra-conductive copper in a field of high-current devices, where in the graphene-reinforced ultra-conductive copper, carbon atoms of graphene are distributed in gaps among copper atoms.

Preferably, the copper atoms are bonded with the carbon atoms of the graphene to form metallic covalent bonds.

Preferably, the graphene-reinforced ultra-conductive copper has CTE of less than 15.7 (μm/m·° C.) at a temperature of 200° C. or less.

Preferably, the high-current devices include electric vehicles or artificial intelligence (AI) servers.

Preferably, the high-current devices include drones, semiconductor electronics, or defense/military-grade wires.

Preferably, the graphene-reinforced ultra-conductive copper is used in a form including a wire, a target, a sheet foil, or a powder.

Preferably, before use, the graphene-reinforced ultra-conductive copper is subjected to a vacuum melting treatment at 1,100° C. to 1,500° C.

The present disclosure provides a use of graphene-reinforced ultra-conductive copper in a field of high-current devices. In the graphene-reinforced ultra-conductive copper, carbon atoms of graphene are distributed in gaps among copper atoms. This structure can lead to an exceptionally robust internal structure for the copper material, and thus makes the copper material have properties such as low temperature coefficient of resistance, small CTE, and high current density. The graphene-reinforced ultra-conductive copper has a 10% to 30% higher current density than oxygen-free copper and a 10% to 30% lower TCR than oxygen-free copper. Therefore, the graphene-reinforced ultra-conductive copper is suitable for devices requiring a high current and a low temperature, including electric vehicles (charging/motors/signals), drones, semiconductor electronics, and defense/military-grade wires. The graphene-reinforced ultra-conductive copper is a novel conductor material that integrates energy conservation, heat reduction, pressure resistance, and cost effectiveness.

In the present disclosure, the graphene-reinforced ultra-conductive copper combining graphene with a copper material is used in high-current devices. According to test results, the graphene-reinforced ultra-conductive copper experiences a small temperature rise and exhibits low TCR when a current flows through the graphene-reinforced ultra-conductive copper. Therefore, the graphene-reinforced ultra-conductive copper enables a large current to pass through in a specified temperature range, which reduces the loss. The graphene-reinforced ultra-conductive copper can enhance the efficiency and reliability in green energy, electric vehicles, semiconductors, and high-frequency communications while mitigating the thermal breakdown associated with copper conductors. As a result, the graphene-reinforced ultra-conductive copper can diminish the consumption of a copper material when in use.

### BRIEF DESCRIPTION OF THE DRAWINGS

FIGS. 1A-1B show schematic diagrams of a microstructure and an image of a morphology of graphene-reinforced ultra-conductive copper;

FIG. 2 shows a micro-differential scanning calorimetry (DSC) thermogram of normal oxygen-free copper;

FIG. 3 shows a micro-DSC thermogram of graphene-reinforced ultra-conductive copper;

FIG. 4 shows a Raman spectrum of graphene;

FIG. 5 shows a Raman spectrum of graphene-reinforced ultra-conductive copper;

FIG. 6 shows comparative current-voltage curves of a normal 4N oxygen-free copper wire (Nippon Cu) and a graphene-reinforced ultra-conductive copper wire;

FIG. 7 shows comparative temperature-resistance curves of a normal 4N oxygen-free copper wire (Nippon Cu) and a graphene-reinforced ultra-conductive copper wire;

FIG. 8 shows a temperature-resistance curve of graphene;

FIG. 9 shows thermal expansion data of a normal copper sheet, an oxygen-free copper sheet, and a graphene-reinforced ultra-conductive copper sheet;

FIG. 10 shows comparative temperature rise data of pure copper and graphene-reinforced ultra-conductive copper;

FIG. 11 is a comparison chart of resistance increase rates and input energies of graphene-reinforced ultra-conductive copper in Example 1 and a normal copper wire;

FIG. 12 is a schematic diagram of a generator and a toroidal transformer that adopt the graphene-reinforced ultra-conductive copper in Example 1; and

FIG. 13 is a schematic diagram of an electric motor adopting the graphene-reinforced ultra-conductive copper in Example 1 and pulse voltages applied to phase coils.

### DETAILED DESCRIPTION OF THE EMBODIMENTS

The present disclosure provides a use of graphene-reinforced ultra-conductive copper in a field of high-current devices. In the graphene-reinforced ultra-conductive copper, carbon atoms of graphene are distributed in gaps among copper atoms.

In the present disclosure, the copper atoms are bonded with the carbon atoms of the graphene to form metallic covalent bonds.

In the present disclosure, the graphene-reinforced ultra-conductive copper is preferably prepared according to the method described in the Chinese patent (CN113073221B).

In the present disclosure, the graphene-reinforced ultra-conductive copper has CTE of less than 15.7 (μm/m·° C.) at a temperature of 200° C. or less.

In the present disclosure, the high-current devices preferably include electric vehicles or AI servers.

In the present disclosure, the high-current devices preferably include drones, semiconductor electronics, or defense/military-grade wires.

In the present disclosure, the graphene-reinforced ultra-conductive copper is used in a form preferably including a wire, a target, a sheet foil, or a powder.

In the present disclosure, before use, the graphene-reinforced ultra-conductive copper is preferably subjected to a vacuum melting treatment at preferably 1,100° C. to 1,500° C. The present disclosure does not have a special restriction on a time of the vacuum melting treatment, which can be adjusted according to actual needs.

The technical solutions provided by the present disclosure will be described in detail below with reference to embodiments, but these embodiments should not be construed as limiting the claimed scope of the present disclosure.

### Example 1

The graphene-reinforced ultra-conductive copper in this example was prepared according to the method described in the Chinese patent CN113073221B.

### Performance Testing

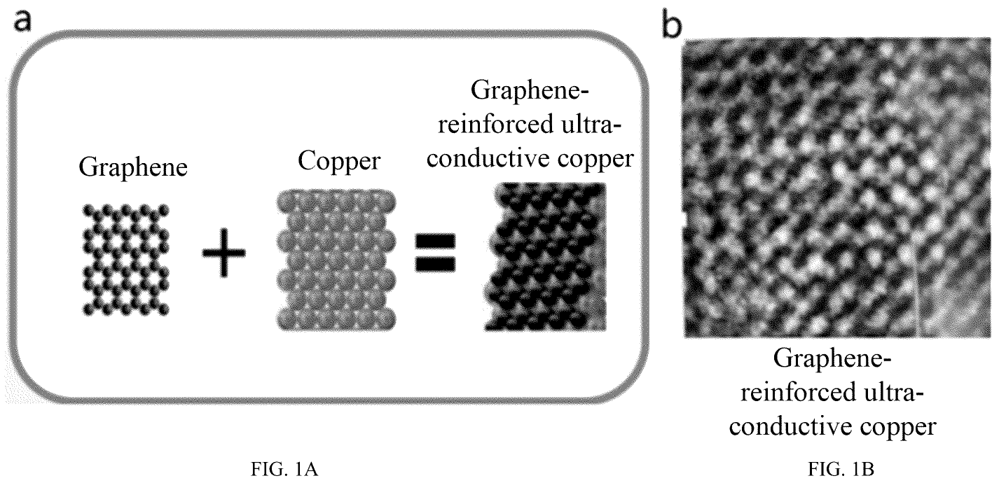

1) The graphene-reinforced ultra-conductive copper prepared in Example 1 (a mass proportion of graphene in the ultra-conductive copper was 700 ppm) was subjected to vacuum melting at 1,500° C. and processed into a master rod with a diameter of 8 mm. This test was conducted with high-resolution transmission electron microscopy (HR TEM), and test results were shown in FIGS. 1A-1B. In FIGS. 1A-1B, FIG. 1A is a schematic diagram of the formation of the ultra-conductive copper. Graphene reacts with copper to produce the graphene-reinforced ultra-conductive copper. FIG. 1B is an electron microscopy image of the graphene-reinforced ultra-conductive copper, where large white dots represent copper atoms and small white dots represent carbon atoms. It can be seen from FIGS. 1A-1B that the graphene-reinforced ultra-conductive copper is a metallic covalently-bonded alloy material produced through the bonding of copper atoms with carbon atoms.
2) Testing in the Precious Instrument Center of National Taiwan University

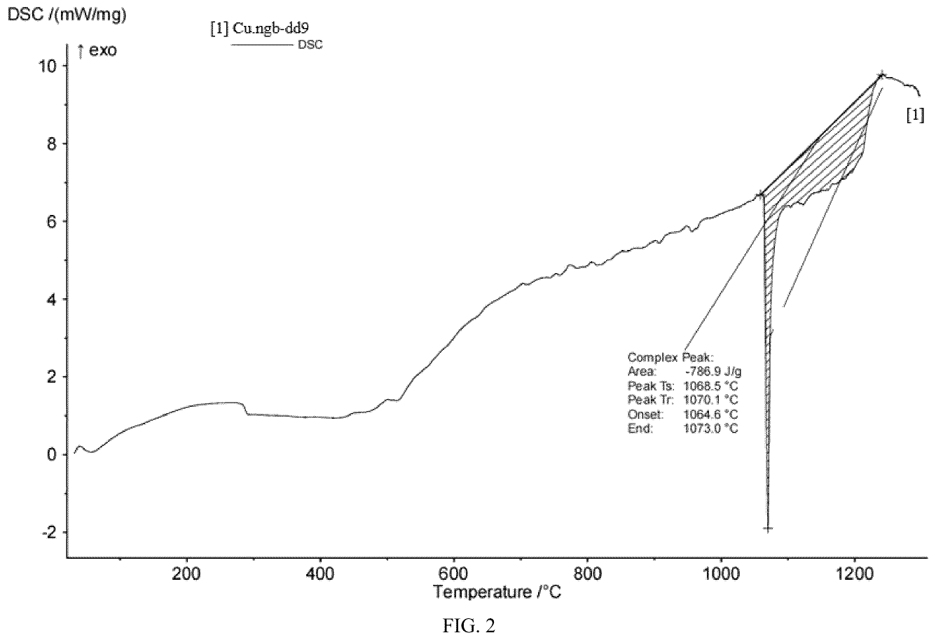

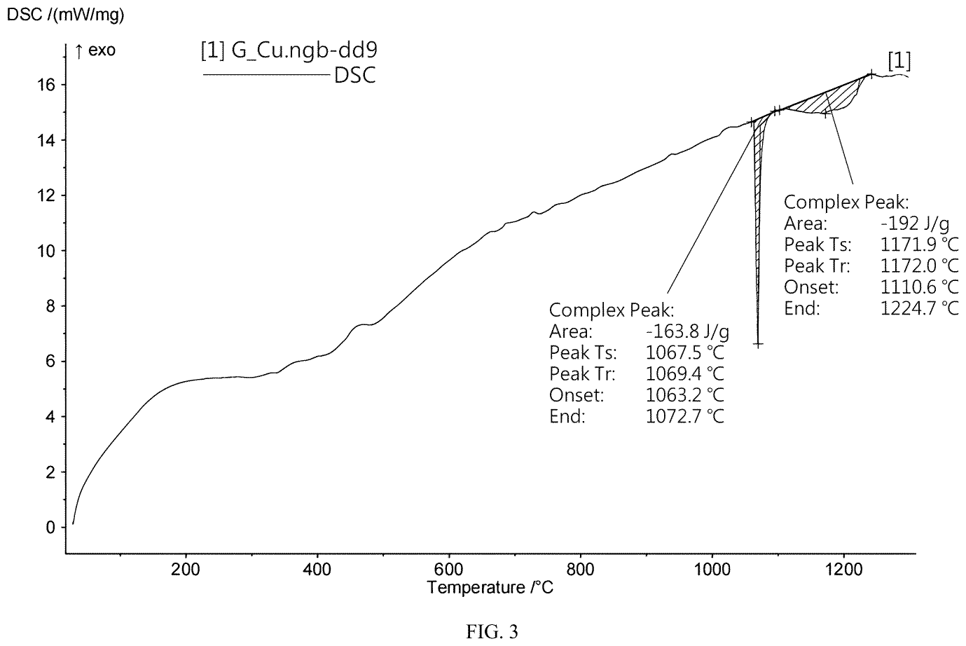

The graphene-reinforced ultra-conductive copper prepared in Example 1 (a mass proportion of graphene in the graphene-reinforced ultra-conductive copper was 2,000 ppm) was subjected to vacuum melting at 1,500° C. and processed into a powder with a particle size of 25 μm. The powder and commercial 4N oxygen-free copper (with an average particle size of 25 μm) each were subjected to micro-DSC analysis, and results were shown in FIG. 2 (4N oxygen-free copper) and FIG. 3 (graphene-reinforced ultra-conductive copper).

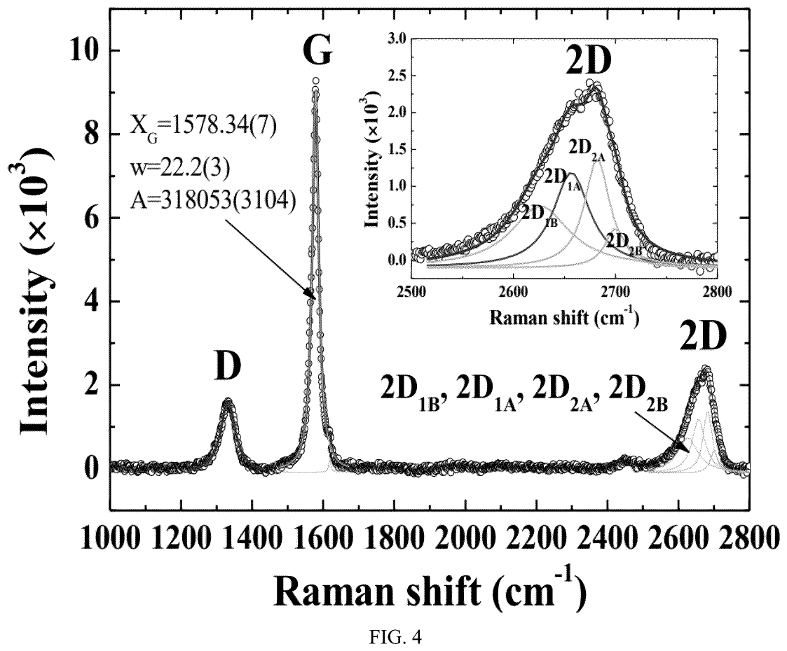

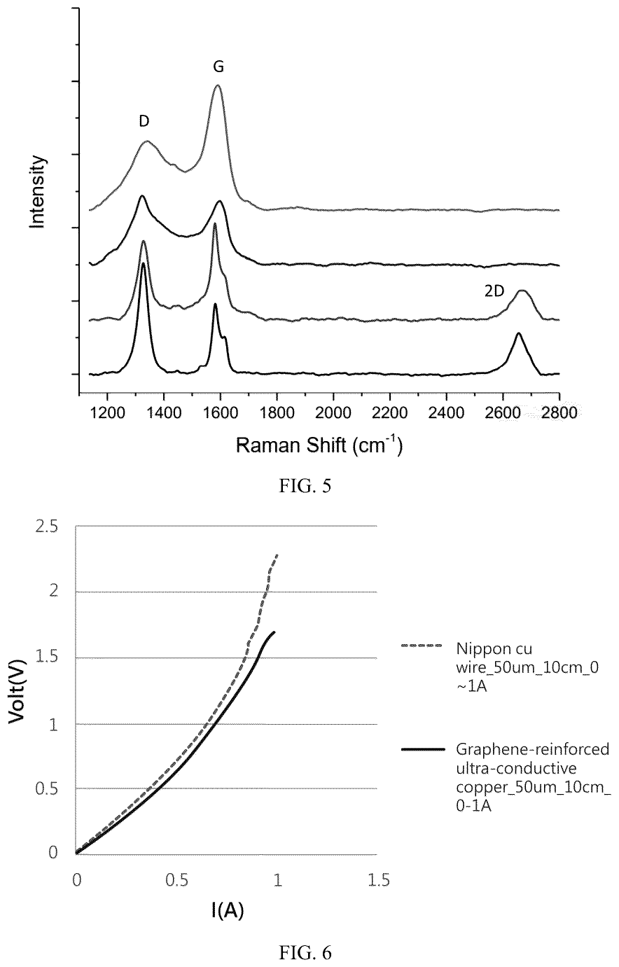

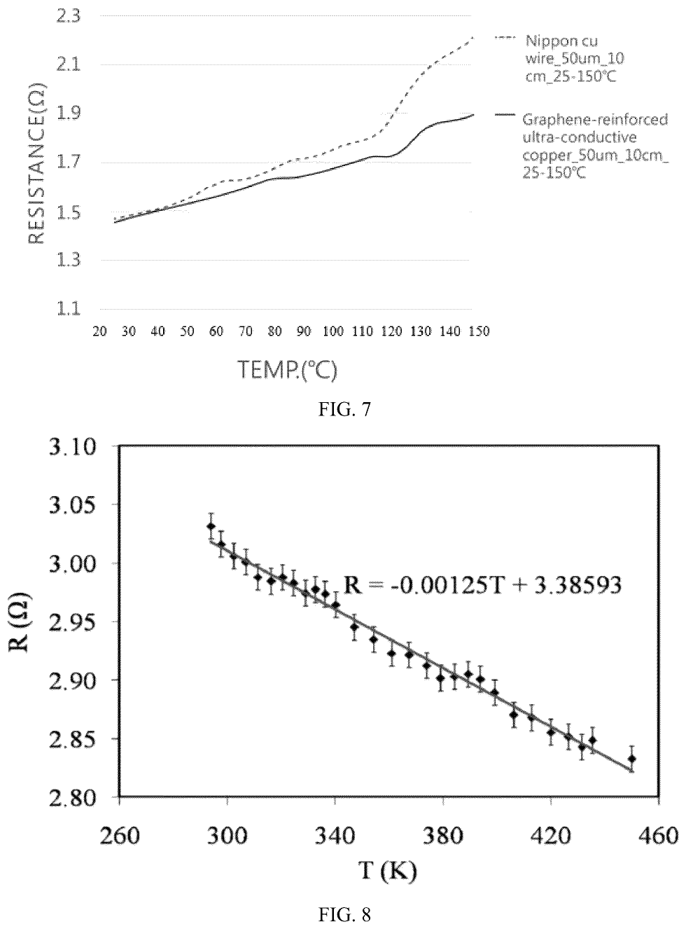

According to the DSC results in FIG. 2, the graphene-reinforced ultra-conductive copper requires a large amount of energy for melting, and has two melting points, indicating that the graphene-reinforced ultra-conductive copper has a strong microstructure with high reliability.
3) The graphene-reinforced ultra-conductive copper prepared in Example 1 was subjected to vacuum melting to a master rod with a diameter of 8 mm, then drawn into a 2 mm ultra-conductive copper wire, and then subjected to Raman spectroscopy testing. Untreated graphene was also subjected to Raman spectroscopy testing. Test results were shown in FIG. 4 to FIG. 5. An inset in FIG. 4 is an enlarged partial view. It can be seen from FIG. 4 to FIG. 5 that the graphene-reinforced ultra-conductive copper possesses the same D and G bonds as graphene.
4) The graphene-reinforced ultra-conductive copper prepared in Example 1 (a mass proportion of graphene in the graphene-reinforced ultra-conductive copper was 700 ppm) was subjected to vacuum melting at 1,500° C., processed into a master rod with a diameter of 8 mm, and then drawn into a ultra-conductive copper wire with a diameter of 50 μm. The ultra-conductive copper wire and a Nippon 50 μm copper wire (commercially available) each were subjected to I-V curve and temperature resistance testing, and test results were shown in FIG. 6 to FIG. 7.

When a current passes through a copper wire, the power dissipation occurs as follows: P=I²R. The electric energy is converted into thermal energy to increase the temperature and impedance of the copper conductor, resulting in large power consumption and high temperature. This vicious circle will cause the breakdown of a system, which is known as thermal breakdown. It can be seen from FIG. 6 to FIG. 7 that the graphene-reinforced ultra-conductive copper in the present disclosure has a lower temperature coefficient than the oxygen-free copper, which can increase the efficiency. When a temperature arises, the graphene-reinforced ultra-conductive copper undergoes a smaller resistance increase than the oxygen-free copper, which can reduce the risk of thermal breakdown, enhance the efficiency, and save the electricity.
5) Resistance

Positive temperature coefficient (PTC): A resistance value of a material increases with the increase of a temperature. The larger the temperature coefficient, the greater the increase in resistance under a same temperature change.

Negative temperature coefficient (NTC): A resistance value of a material decreases with the increase of a temperature. Resistance values of both semiconductors and insulators decrease with the increase of a temperature. Graphene, semiconductors, and ceramics all exhibit NTC of resistance.

FIG. 8 shows a temperature-resistance curve of graphene. FIG. 8 comes from the prior art (Supplementary Information, November 2011. High Sensitivity Gas Detection Using a Macroscopic Three-Dimensional Graphene Foam Network.). It can be seen that graphene has NTC of resistance. The pure copper has TCR of about 0.0039, and the graphene-reinforced ultra-conductive copper has TCR of about 0.0030 to 0.0033. The graphene-reinforced ultra-conductive copper has smaller TCR than the pure copper.

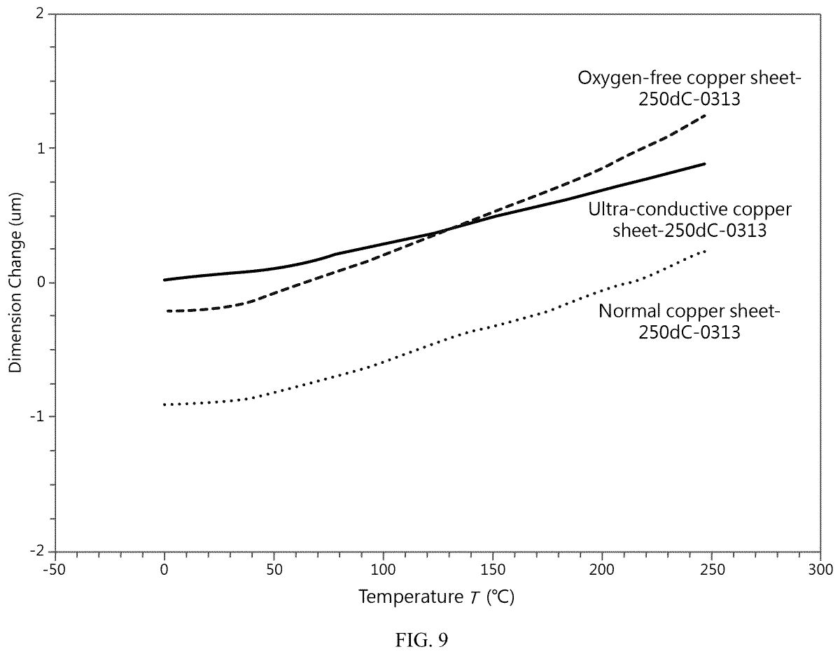

6) The graphene-reinforced ultra-conductive copper prepared in Example 1 was subjected to vacuum melting, then processed into a copper ingot, and then calendered into a 0.2 mm ultra-conductive copper sheet. The ultra-conductive copper sheet, an oxygen-free copper sheet (4N copper sheet with a thickness of 0.2 mm), and a normal copper sheet each were subjected to CTE testing, and test results were shown in FIG. 9 and Table 1.

TABLE 1
CTE data for different copper sheet samples

| | CTE(μm/m · ° C.) | | | | |
|---|---|---|---|---|---|
| Sample | 0-50° C. | 50-100° C. | 100-150° C. | 150-200° C. | 200-250° C. |
| Normal copper | 5.067 | 16.08 | 18.83 | 16.74 | 20.82 |
| sheet | | | | | |
| Oxygen-free | 6.261 | 14.68 | 16.48 | 17.60 | 22.26 |
| copper sheet | | | | | |
| Ultra-conductive | 6.519 | 14.90 | 15.11 | 15.65 | 17.18 |
| copper sheet | | | | | |

It can be seen from Table 1 and FIG. 9 that, at 100° C. to 150° C., CTE of the graphene-reinforced ultra-conductive copper is 8.3% lower than CTE of the oxygen-free copper sheet, and at 200° C. to 250° C., CTE of the graphene-reinforced ultra-conductive copper is 22.8% lower than CTE of the oxygen-free copper sheet.
7) Current and temperature rise comparison:

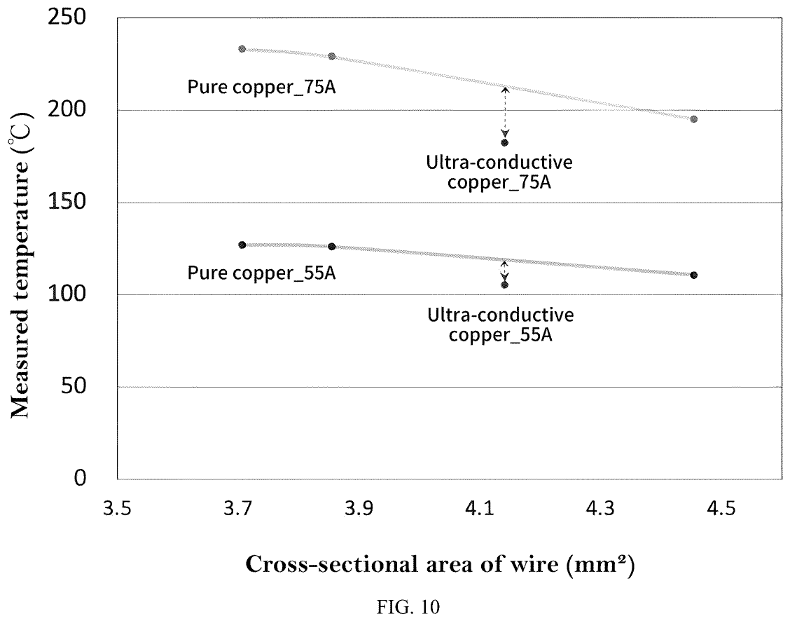

Test materials: 1. Pure copper wire, which was a 128-strand twisted wire with a single-strand diameter of 0.2 mm.
2. The graphene-reinforced ultra-conductive copper prepared in Example 1 (a mass proportion of graphene in the graphene-reinforced ultra-conductive copper was 700 ppm) was subjected to vacuum melting at 1,500° C., processed into a master rod with a diameter of 8 mm, and then drawn into a wire with a diameter of 0.2 mm. 128 wires were twisted to produce a twisted wire. Test results were shown in FIG. 10 (comparison of input currents (55 A/75 A) and temperatures of pure copper and ultra-conductive copper wires) and Table 2.

TABLE 2
Temperature rise data for the pure copper and
graphene-reinforced ultra-conductive copper

| Input current | Pure copper | Ultra-conductive | Temperature |
|---|---|---|---|
| and measured | wire with a | copper wire with | fall of ultra- |
| temperature | cross-sectional | a cross-sectional | conductive |
| rise of a wire | area: 4.14 mm² | area of 4.14 mm² | copper/% |
| 55 A (temperature | 119.3° C. | 105.2 | 11.8 |
| rise) | | | |
| 75 A (temperature | 213.9 | 182.5 | 14.7 |
| rise) | | | |

It can be seen from FIG. 10 and Table 2 that at 55 A, a temperature of the ultra-conductive copper decreases by 14° C., and at 75 A, the temperature of the ultra-conductive copper decreases by 31° C. Under a same cross-sectional area, the graphene-reinforced ultra-conductive copper enables a 10% to 20% higher current to pass through than the pure copper.
8) Field testing in fast-charging piles:

Test materials: 1. Oxygen-free copper wire with a single-strand diameter of 0.2 mm. A fast charging cable was produced from a plurality of twisted wires.
2. The graphene-reinforced ultra-conductive copper prepared in Example 1 at 700 ppm was subjected to vacuum melting to a master rod with a diameter of 8 mm and then drawn into a wire with a diameter of 0.2 mm. A fast charging cable was produced from a plurality of twisted wires. The manufacturing was conducted by the same wire drawing factory as above with the D connector unchanged (the same connector material as above), except that the graphene-reinforced ultra-conductive copper was adopted as a conductor wire material. With a water flow rate and a fan speed each reduced by 50%, the fast charging cables were tested on a 600 A direct current (DC) electric vehicle. A temperature difference between the graphene-reinforced ultra-conductive copper and 4N copper was determined.

Limitations: An internal temperature of a wire must not exceed 125° C. A temperature of the D+ connector must not exceed 90° C. Test results were shown in Table 3.

TABLE 3
Fast-charging data for the 4N copper and graphene-
reinforced ultra-conductive copper

| | | Internal | Temperature |
|---|---|---|---|
| | | temperature | of a D+ |
| | Charging time | of a wire | connector |
| Wire | at 600 A | (° C.) | (° C.) |
| 4N copper | 9 min | 125.6 | 77 |
| Graphene-reinforced | 13 min | 109 | 90 |
| ultra-conductive copper | | | |
| Graphene-reinforced | 23 min | 113 | 99 |
| ultra-conductive copper | | | |

It can be seen from Table 3 that the graphene-reinforced ultra-conductive copper, as a wire conductor, can significantly reduce a temperature and can increase a current by about 20%.

If the graphene-reinforced ultra-conductive copper is adopted as the D+ connector material, the fast-charging time can be extended. The graphene-reinforced ultra-conductive copper facilitates the development of fast charging at 800 A and 1,000 A.
9) 20 cm of each of ultra-conductive copper wires with different diameters was taken. An adjustable current source was applied to two ends, and a temperature was measured with a thermocouple at a center point. In a 25° C. environment, an output current of a current source was adjusted until the temperature measured by the thermocouple was stabilized at 75° C., which was a current-carrying capacity. The thinner the wire, the larger the improvement in a current density.

TABLE 4
Current-carrying capacity data for the normal oxygen-free copper and ultra-conductive copper

| | | | | Ultra-conductive copper (field testing at an | | | |
|---|---|---|---|---|---|---|---|
| Normal oxygen-free copper (with reference | | | | ambient temperature of 25° C.) | | | |
| to American wire gauge (AWG) table) | | | | | | Impedance | |
| Conduct | Cross- | Impedance | Current- | Conduct | Cross- | of ultra- | Current- |
| or | sectional | of normal | carrying | or | sectional | conductive | carrying |
| diameter | area | copper | capacity | diameter | area | copper | capacity |
| (mm) | (mm²) | (mΩ/m) | (A)@75° C. | (mm) | (mm²) | (mΩ/m) | (A)@75° C. |
| 2.053 | 3.31 | 5.211 | 25 | 2.03 | 3.24 | 5.268 | 25.5 |
| 1.024 | 0.823 | 20.95 | 14 | 1.0 | 0.785 | 21.8 | 17.1 |
| 0.812 | 0.518 | 33.31 | 11 | 0.807 | 0.511 | 33.58 | 13.7 |
| 0.405 | 0.129 | 133.9 | 2.2 | 0.38 | 0.113 | 150.13 | 5.44 |
| 0.321 | 0.081 | 212.9 | 1.4 | 0.295 | 0.068 | 248.52 | 4.24 |
| 0.16 | 0.02 | 856 | 0.3 | 0.103 | 0.008 | 2123.9 | 1.4 |

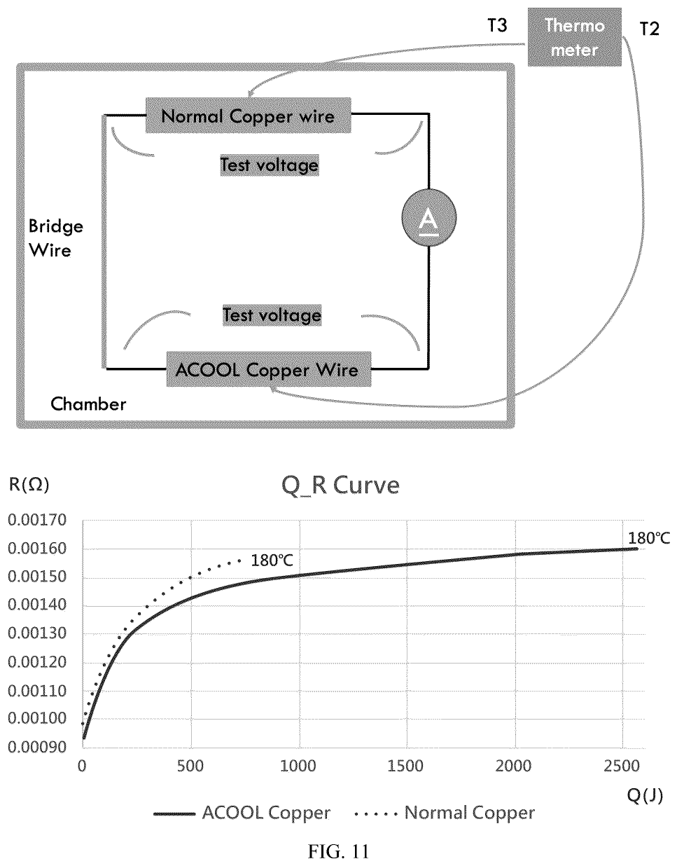

It can be seen from Table 4 that the graphene-reinforced ultra-conductive copper has a significantly-higher current-carrying capacity than the normal oxygen-free copper under similar wire diameters. The thinner the wire, the larger the difference. Since a current density is equal to current-carrying capacity/cross-sectional area, it is obvious that a current density of the graphene-reinforced ultra-conductive copper is significantly higher than a current density of the normal oxygen-free copper.
10) The graphene-reinforced ultra-conductive copper prepared in Example 1 was tested for a resistance rise rate and an input energy, and compared with a normal copper wire. A schematic diagram of the testing and test results were shown in FIG. 11.

In a same test, a constant current was input simultaneously into the normal copper wire (normal copper) and the ultra-conductive copper wire (ACOOL copper), and test results were shown in FIG. 11. FIG. 11 is a comparison chart of resistance increase rates and input energies of the graphene-reinforced ultra-conductive copper in Example 1 and the normal copper wire. Under a same energy input, the ultra-conductive copper wire has a lower resistance rise rate than the normal copper wire, indicating that the resistance of the ultra-conductive copper is far lower than the resistance of the normal copper.
11) Application of ultra-conductive copper

Due to the slow increase in impedance of a ultra-conductive copper wire when a current is input, there will be a large induced current in a generator adopting the ultra-conductive copper wire.

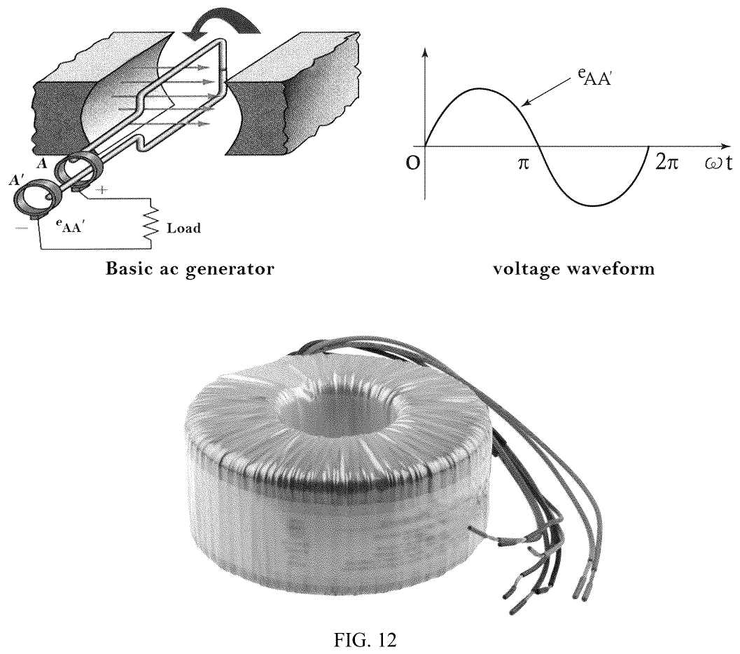

FIG. 12 is a schematic diagram of a generator and a toroidal transformer that adopt the graphene-reinforced ultra-conductive copper in Example 1. As shown in FIG. 12, the actual measurements of an output power of the generator indicate that a power of electricity generation increases by 15% to 20%. The actual measurements for the toroidal transformer show that an output power of the toroidal transformer increases by 15% to 20%.
12) Application in electric vehicles

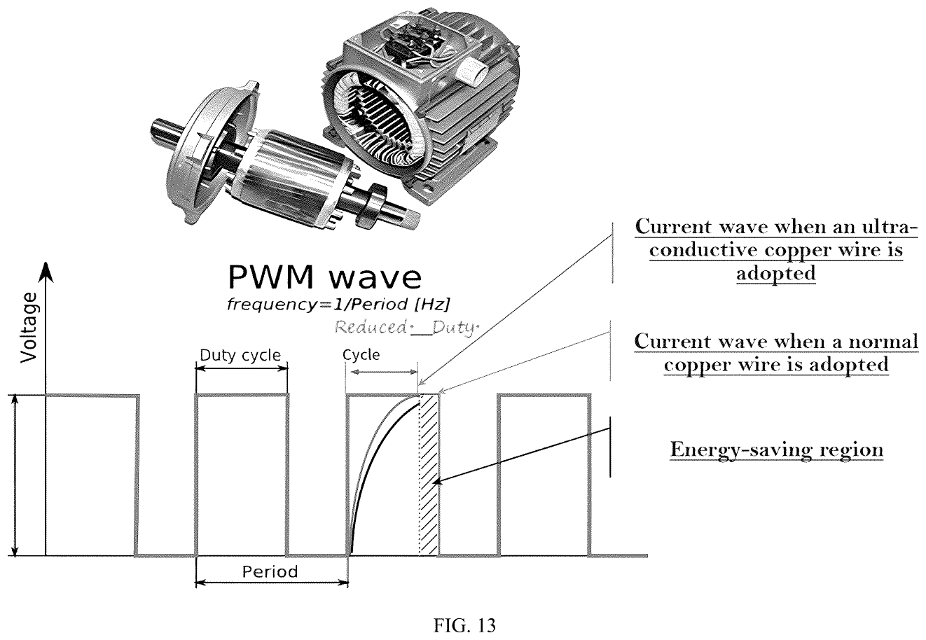

FIG. 13 is a schematic diagram of an electric motor adopting the graphene-reinforced ultra-conductive copper in Example 1 and pulse voltages applied to phase coils. As shown in FIG. 13, a pulse voltage of a drive motor adopting a ultra-conductive copper coil can reduce a duty cycle to avoid overcharging, which can reduce the energy consumption by 15% to 20%.

The above are merely preferred implementations of the present disclosure. It should be noted that those of ordinary skill in the art may further make several improvements and modifications without departing from the principle of the present disclosure, but such improvements and modifications should be deemed as falling within the protection scope of the present disclosure.

What is claimed is:

1. A method for using a graphene-reinforced ultra-conductive copper in a field of high-current devices, wherein in the graphene-reinforced ultra-conductive copper, carbon atoms of graphene are distributed in gaps among copper atoms.

2. The method according to claim 1, wherein the copper atoms are bonded with the carbon atoms of the graphene to form metallic covalent bonds.

3. The method according to claim 1, wherein the graphene-reinforced ultra-conductive copper has a coefficient of thermal expansion (CTE) of less than 15.7 μm/(m·° C.) at a temperature of 200° C. or less.

4. The method according to claim 1, wherein the high-current devices comprise electric vehicles or artificial intelligence (AI) servers.

5. The method according to claim 1, wherein the high-current devices comprise drones, semiconductor electronics, or defense/military-grade wires.

6. The method according to claim 1, wherein the graphene-reinforced ultra-conductive copper is used in a form comprising a wire, a target, a sheet foil, or a powder.

7. The method according to claim 1, wherein before use, the graphene-reinforced ultra-conductive copper is subjected to a vacuum melting treatment at 1,100° C. to 1,500° C.

8. The method according to claim 2, wherein before use, the graphene-reinforced ultra-conductive copper is subjected to a vacuum melting treatment at 1,100° C. to 1,500° C.

9. The method according to claim 3, wherein before use, the graphene-reinforced ultra-conductive copper is subjected to a vacuum melting treatment at 1,100° C. to 1,500° C.

10. The method according to claim 4, wherein before use, the graphene-reinforced ultra-conductive copper is subjected to a vacuum melting treatment at 1,100° C. to 1,500° C.

11. The method according to claim 5, wherein before use, the graphene-reinforced ultra-conductive copper is subjected to a vacuum melting treatment at 1,100° C. to 1,500° C.

12. The method according to claim 6, wherein before use, the graphene-reinforced ultra-conductive copper is subjected to a vacuum melting treatment at 1,100° C. to 1,500° C.
